(19) United States
(12) Patent Application Publication
(10) Pub. No.: US 2024/0394911 A1
(43) Pub. Date: Nov. 28, 2024

(54) POSITION ESTIMATING DEVICE, METHOD, AND COMPUTER PROGRAM FOR ESTIMATING POSITION

(71) Applicant: Woven by Toyota, Inc., Tokyo (JP)

(72) Inventor: Mamoru TSUKAMOTO, Tokyo-to (JP)

(73) Assignee: Woven by Toyota, Inc., Tokyo (JP)

(21) Appl. No.: 18/627,921

(22) Filed: Apr. 5, 2024

(30) Foreign Application Priority Data
May 23, 2023 (JP) 2023-084529

(51) Int. Cl. G06T 7/73; G06V 10/44; G06V 20/52; G06V 20/56

(52) U.S. Cl. CPC G06T 7/73; G06V 10/44; G06V 20/52; G06V 20/56

(57) ABSTRACT

A position estimating device includes a processor configured to detect a first position of a vehicle traveling a predetermined road section at a first time, based on a fixed sensor installed on or near the predetermined road section, estimate a second position of the vehicle at a second time, based on the first position of the vehicle at the first time, the second time being a time when a vehicle-captured image representing a predetermined feature is generated by a vehicle-mounted camera mounted on the vehicle, and estimate a real-space position of the predetermined feature, based on the estimated second position.

### FIELD

The present invention relates to a position estimating device, a method, and a computer program for estimating the position of a predetermined feature represented in an image generated by a vehicle-mounted camera.

### BACKGROUND

To generate or update a highly precise map to which an autonomous vehicle-driving system refers in order to execute autonomous driving control of a vehicle, it is desirable to accurately detect the positions of those features on or around roads which relate to travel of vehicles. Thus, a technique has been proposed to detect a feature on the basis of an image generated by a camera mounted on a vehicle that actually travels along a road (see Japanese Patent JP7126629B).

An information integration device disclosed in JP7126629B recognizes one or more first features around a moving object, based on sensor information obtained from a sensor provided to the moving object, and generates first feature information indicating the first features. The information integration device obtains second feature information indicating one or more second features recognized around the moving object from an external device or from both the external device and map information, and identifies the same feature from among the one or more first features indicated by the first feature information and the one or more second features indicated by the second feature information. The information integration device generates correction information used for correcting at least one of the first and second feature information, based on the difference in position between the first and second features identified as the same feature, corrects at least one of the first and second feature information, using the correction information, and then integrates the first and second feature information to generate integrated feature information.

### SUMMARY

When the accuracy of detection of the position of a vehicle is insufficient, the accuracy of the position of a feature detected from a vehicle-captured image obtained by a vehicle-mounted camera may also be insufficient. In the above-described technique, generation of correction information requires that information on the same feature be included in the first and second feature information. However, since a feature represented in sensor information obtained by a sensor provided to a moving object is not always indicated by feature information obtained from an external device, it is therefore desirable to precisely estimate the position of a feature represented in a vehicle-captured image.

Accordingly, it is an object of the present invention to provide a position estimating device that can accurately estimate the position of a feature represented in a vehicle-captured image obtained by a camera mounted on a vehicle.

According to an embodiment, a position estimating device is provided. The position estimating device includes a processor configured to: detect a first position of a vehicle traveling a predetermined road section at a first time, based on a fixed sensor installed on or near the predetermined road section, estimate a second position of the vehicle at a second time, based on the first position of the vehicle at the first time, the second time being a time when a vehicle-captured image representing a predetermined feature is generated by a vehicle-mounted camera mounted on the vehicle, and estimate a real-space position of the predetermined feature, based on the estimated second position.

The fixed sensor is preferably a surveillance camera that generates surveillance images representing the predetermined road section at predetermined intervals. In the position estimating device, the processor preferably detects the position of the vehicle from each of the surveillance images generated at different times; and estimates the second position, using the position of the vehicle detected from a surveillance image generated at a time closest to the second time of the surveillance images as the first position.

Depending on the difference between the first position and a first uncorrected position of the vehicle measured at the first time by a satellite positioning device mounted on the vehicle, the processor preferably corrects a second uncorrected position of the vehicle measured at the second time by the satellite positioning device, thereby estimating the second position.

The processor of the position estimating device is preferably further configured to detect the predetermined feature from the vehicle-captured image generated at the second time. The processor preferably estimates the real-space position of the predetermined feature, based on the position of the predetermined feature in the vehicle-captured image and the second position.

According to another embodiment, a method for estimating a position is provided. The method includes detecting a first position of a vehicle traveling a predetermined road section at a first time, based on a fixed sensor installed on or near the predetermined road section; estimating a second position of the vehicle at a second time, based on the first position of the vehicle at the first time, the second time being a time when a vehicle-captured image representing a predetermined feature is generated by a vehicle-mounted camera mounted on the vehicle; and estimating a real-space position of the predetermined feature, based on the estimated second position.

According to still another embodiment, a non-transitory recording medium that stores a computer program for estimating a position is provided. The computer program includes instructions causing a computer to execute a process including detecting a first position of a vehicle traveling a predetermined road section at a first time, based on a fixed sensor installed on or near the predetermined road section; estimating a second position of the vehicle at a second time, based on the first position of the vehicle at the first time, the second time being a time when a vehicle-captured image representing a predetermined feature is generated by a vehicle-mounted camera mounted on the vehicle; and estimating a real-space position of the predetermined feature, based on the estimated second position.

The position estimating device according to the present disclosure has an advantageous effect of being able to accurately estimate the position of a feature represented in an image obtained by a camera mounted on a vehicle.

### BRIEF DESCRIPTION OF DRAWINGS

FIG. 1 schematically illustrates the configuration of a feature data collecting system equipped with a position estimating device.

FIG. 2 schematically illustrates the configuration of a vehicle.

FIG. 3 illustrates the hardware configuration of a data acquisition device.

FIG. 4 illustrates the hardware configuration of a server, which is an example of the position estimating device.

FIG. 5 is a functional block diagram of a processor of the server, related to a position estimating process.

FIG. 6 is a schematic diagram illustrating estimation of the position of a feature.

FIG. 7 is an operation flowchart of the position estimating process.

### DESCRIPTION OF EMBODIMENTS

A position estimating device, a method for estimating a position executed by the position estimating device, and a computer program for estimating a position will now be described with reference to the attached drawings. Regarding a predetermined region, the position estimating device collects vehicle-captured images representing features related to travel of vehicles from one or more communicable vehicles, detects a predetermined feature that relates to travel of vehicles and that is represented in the collected vehicle-captured images, and estimates the position of the feature. To this end, the position estimating device detects a first position of a vehicle traveling a predetermined road section at a first time, based on a fixed sensor installed on or near the predetermined road section. The position estimating device estimates a second position of the vehicle at a second time of generation of a vehicle-captured image representing a predetermined feature, based on the first position of the vehicle at the first time, and estimates the position of the predetermined feature, based on the estimated second position.

Examples of the predetermined feature to be detected include various traffic signs, various road markings, traffic lights, and other features related to travel of vehicles.

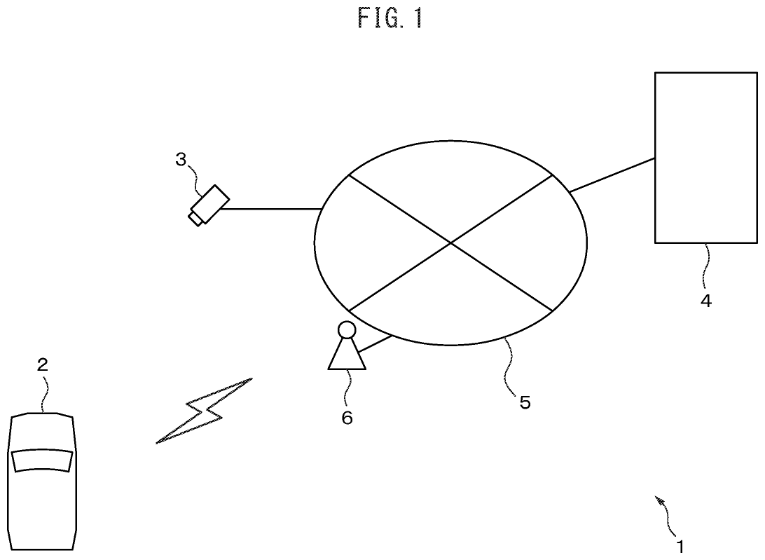

FIG. 1 schematically illustrates the configuration of a feature data collecting system equipped with the position estimating device. In the present embodiment, the feature data collecting system 1 includes at least one vehicle 2, at least one fixed sensor 3, and a server 4, which is an example of the position estimating device. Each vehicle 2 accesses a wireless base station 6, which is connected via a gateway (not illustrated) to a communication network 5 connected with the server 4, thereby connecting to the server 4 via the wireless base station 6 and the communication network 5. Each fixed sensor 3 is also connected to the communication network 5 via a gateway, and connects to the server 4 via the communication network 5. For simplicity, FIG. 1 illustrates a single vehicle 2, but the feature data collecting system 1 may include multiple vehicles 2. FIG. 1 also illustrates a single fixed sensor 3, but multiple fixed sensors 3 may be included. FIG. 1 also illustrates a single wireless base station 6, but the communication network 5 may be connected with multiple wireless base stations 5.

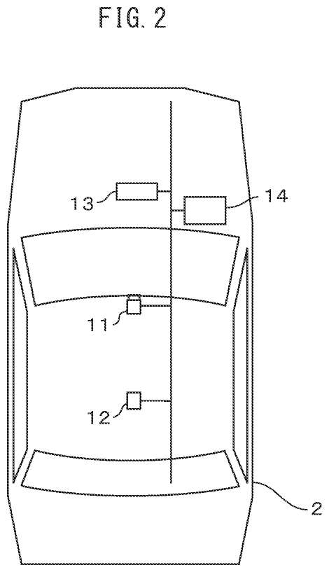

FIG. 2 schematically illustrates the configuration of the vehicle 2. The vehicle 2 includes a camera 11, a GPS receiver 12, a wireless communication terminal 13, and a data acquisition device 14, which are communicably connected via an in-vehicle network conforming to a standard such as a controller area network. The vehicle 2 may further include a navigation device (not illustrated) that searches for a planned travel route of the vehicle 2 and that navigates the vehicle 2 to travel along the planned travel route.

The camera 11, which is an example of the vehicle-mounted camera, includes a two-dimensional detector constructed from an array of optoelectronic transducers, such as CCD or C-MOS, having sensitivity to visible light and a focusing optical system that forms an image of a target region on the two-dimensional detector. The camera 11 is mounted, for example, in the interior of the vehicle 2 so as to be oriented, for example, to the front of the vehicle 2. The camera 11 takes pictures of a region in front of the vehicle 2 every predetermined capturing period (e.g., 1/30 to 1/10 seconds), and generates images representing the region. An image obtained by the camera 11 is an example of a vehicle-captured image, and may be a color or grayscale image. The vehicle 2 may include multiple cameras 11 taking pictures in different orientations or having different focal lengths.

Every time an image is generated, the camera 11 outputs the generated image to the data acquisition device 14 via the in-vehicle network.

The GPS receiver 12, which is an example of the satellite positioning device, receives GPS signals from GPS satellites at predetermined intervals, and determines the position of the vehicle 2, based on the received GPS signals. The predetermined intervals at which the GPS receiver 12 determines the position of the vehicle 2 may differ from the capturing period of the camera 11. The GPS receiver 12 outputs positioning information indicating the result of determination of the position of the vehicle 2 based on the GPS signals to the data acquisition device 14 via the in-vehicle network at predetermined intervals. In the positioning information, the GPS receiver 12 may include an index indicating the accuracy of the determined position, such as the intensity of received GPS signals or the number of satellites from which GPS signals can be received. Instead of the GPS receiver 12, the vehicle 2 may include a receiver conforming to another satellite positioning system. In this case, the receiver determines the position of the vehicle 2.

The wireless communication terminal 13, which is an example of a communication unit, is a device to execute a wireless communication process conforming to a predetermined standard of wireless communication, and accesses, for example, the wireless base station 6 to connect to the server 4 via the wireless base station 6 and the communication network 5. The wireless communication terminal 13 generates an uplink radio signal that includes, for example, feature data received from the data acquisition device 14 and including an image generated by the camera 11. The wireless communication terminal 13 transmits the uplink radio signal to the wireless base station 6 to transmit the image and other data to the server 4. In addition, the wireless communication terminal 13 receives a downlink radio signal from the wireless base station 6, and passes a collection instruction from the server 4 included in the radio signal to the data acquisition device 14 or an electronic control unit (ECU, not illustrated) that controls travel of the vehicle 2.

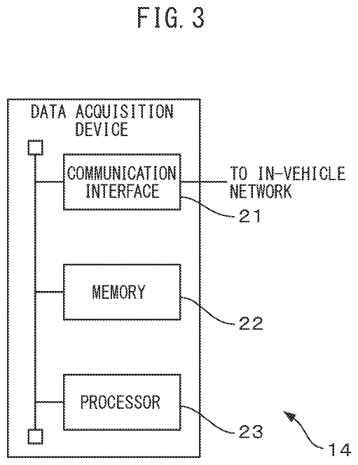

FIG. 3 illustrates the hardware configuration of the data acquisition device. The data acquisition device 14 generates feature data, based on an image generated by the camera 11, and further generates travel information indicating motion of the traveling vehicle 2. To achieve this, the data acquisition device 14 includes a communication interface 21, a memory 22, and a processor 23.

The communication interface 21, which is an example of an in-vehicle communication unit, includes an interface circuit for connecting the data acquisition device 14 to the in-vehicle network. In other words, the communication interface 21 is connected to the camera 11, the GPS receiver 12, and the wireless communication terminal 13 via the in-vehicle network. Every time an image is received from the camera 11, the communication interface 21 passes the received image to the processor 23. Every time positioning information is received from the GPS receiver 12, the communication interface 21 passes the received positioning information to the processor 23. In addition, the communication interface 21 receives a collection instruction of feature data from the server 4 via the wireless communication terminal 13, and passes the collection instruction to the processor 23. In addition, the communication interface 21 outputs feature data received from the processor 23 to the wireless communication terminal 13 via the in-vehicle network.

The memory 22 includes, for example, volatile and nonvolatile semiconductor memories. The memory 22 may further include other storage, such as a hard disk drive. The memory 22 stores various types of data used in a process related to generation of feature data, which is executed by the processor 23 of the data acquisition device 14. Such data includes, for example, identifying information of the vehicle 2 and parameters of the camera 11, such as the height of the mounted position, the orientation, the focal length, and the angle of view of the camera 11. The memory 22 may also store images received from the camera 11 and positioning information received from the GPS receiver 12 for a certain period. In addition, the memory 22 stores information indicating a target region for generating and collecting feature data (hereafter a “collection target region”) specified in a collection instruction of feature data. The memory 22 may further store a computer program for implementing processes executed by the processor 23. The processor 23 includes one or more central processing units (CPUs) and a peripheral circuit thereof. The processor 23 may further include another operating circuit, such as a logic-arithmetic unit, an arithmetic unit, or a graphics processing unit. The processor 23 stores images received from the camera 11 and positioning information received from the GPS receiver 12 in the memory 22. In addition, the processor 23 executes the process related to generation of feature data at predetermined intervals (e.g., 0.1 to 10 seconds) during travel of the vehicle 2.

As the process related to generation of feature data, for example, the processor 23 determines whether the position of the vehicle 2 indicated by positioning information received from the GPS receiver 12 is within a collection target region. When the position of the vehicle is within a collection target region, the processor 23 generates feature data, based on an image received from the camera 11.

Feature data represents a feature related to travel of vehicles. In the present embodiment, the processor 23 includes an image generated by the camera 11, the time of generation of the image, the position of the vehicle 2 at the time indicated by positioning information, the travel direction of the vehicle 2 at the time, and parameters of the camera 11, such as the height of the mounted position, the orientation, the focal length, and the angle of view of the camera 11, in feature data. The processor 23 obtains information indicating the travel direction of the vehicle 2 from the ECU of the vehicle 2 or an orientation sensor (not illustrated). When the time of generation of the image differs from the time of acquisition of the latest positioning information, the processor 23 obtains odometry information of the vehicle 2 used for dead reckoning, such as wheel speeds, accelerations, and angular speeds, from the time of acquisition of the latest positioning information until the time of generation of the image, from the ECU. The processor 23 may determine the position and travel direction of the vehicle 2 at the time of generation of the image by correcting, with the odometry information, the position of the vehicle 2 indicated by the latest positioning information and the travel direction of the vehicle 2. Odometry information is an example of motion information indicating motion of the vehicle 2. Every time feature data is generated, the processor 23 transmits the generated feature data to the server 4 via the wireless communication terminal 13. The processor 23 may include multiple images, the times of generation of the respective images, and the positions and travel directions of the vehicle 2 in a single piece of feature data. The processor 23 may transmit the parameters of the camera 11, together with identifying information of the vehicle 2, to the server 4 via the wireless communication terminal 13, separately from feature data.

The processor 23 further generates travel information of the vehicle 2 after predetermined timing (e.g., timing at which an ignition switch of the vehicle 2 is turned on), and transmits the travel information to the server 4 via the wireless communication terminal 13. The processor 23 includes a series of pieces of positioning information obtained after the predetermined timing, the times of determination of the positions of the vehicle 2 in the respective pieces of positioning information, and odometry information obtained from the ECU, in travel information. The processor 23 may further include identifying information of the vehicle 2 in travel information and feature data.

The fixed sensor 3 is installed on or near a predetermined road section, and can sense a vehicle 2 traveling the predetermined road section. The predetermined road section may be any section, but is preferably a road section that is likely to be traveled by a vehicle 2 collecting feature data. The fixed sensor 3 may be, for example, a camera installed so that its capture area includes the predetermined road section (hereafter referred to as a “surveillance camera” to distinguish the camera from the camera mounted on the vehicle 2). In this case, the surveillance camera, which is the fixed sensor 3, is installed on a support member provided so as to straddle the predetermined road section or on a pole installed next to the predetermined road section, and is oriented to the predetermined road section. The surveillance camera takes pictures of the predetermined road section at predetermined intervals to generate images representing the predetermined road section. Every time an image is generated, the surveillance camera transmits the generated image and the time of generation of the image to the server 4 via the communication network 5. An image generated by the surveillance camera is an example of a fixed sensor signal for sensing a vehicle 2 traveling the predetermined road section. In the following, an image generated by the surveillance camera will be referred to as a “surveillance image” to distinguish the image from a vehicle-captured image generated by the vehicle-mounted camera 11.

The fixed sensor 3 may be a vehicle sensor of a loop coil type using a loop coil buried under the road surface of the predetermined road section. Alternatively, the fixed sensor 3 may be a vehicle sensor of an ultrasonic type with an ultrasonic transmitter-receiver installed, for example, on a road shoulder of the predetermined road section. Alternatively, the fixed sensor 3 may be a beacon device capable of interactive communication with a device mounted on the vehicle 2. In the case where the fixed sensor 3 is one of these sensors, every time a vehicle passing along the predetermined road section is sensed, the fixed sensor 3 transmits a vehicle sensing signal indicating that a vehicle has been sensed and the time of sensing of the vehicle (hereafter simply the “sensing time”) to the server 4 via the communication network 5. A vehicle sensing signal is another example of a fixed sensor signal.

The following describes the server 4, which is an example of the position estimating device.

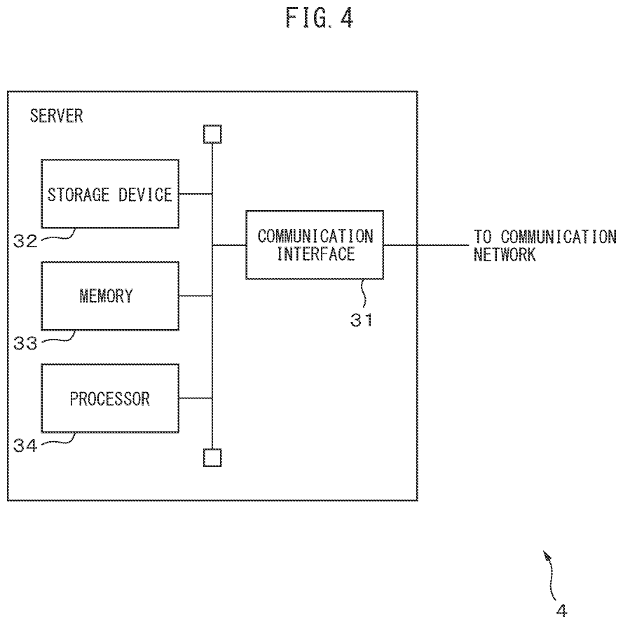

FIG. 4 illustrates the hardware configuration of the server 4, which is an example of the position estimating device. The server 4 includes a communication interface 31, a storage device 32, a memory 33, and a processor 34. The communication interface 31, the storage device 32, and the memory 33 are connected to the processor 34 via a signal line. The server 4 may further include an input device, such as a keyboard and a mouse, and a display device, such as a liquid crystal display.

The communication interface 31, which is an example of a communication unit, includes an interface circuit for connecting the server 4 to the communication network 5. The communication interface 31 is configured to be communicable with each vehicle 2 via the communication network 5 and the wireless base station 6. More specifically, the communication interface 31 passes, to the processor 34, feature data or travel information received from a vehicle 2 via the wireless base station 6 and the communication network 5. The communication interface 31 transmits a collection instruction received from the processor 34 to a vehicle 2 via the communication network 5 and the wireless base station 6. In addition, the communication interface 31 passes, to the processor 34, a fixed sensor signal received from a fixed sensor 3 via the communication network 5.

The storage device 32, which is an example of a storage unit, includes, for example, a hard disk drive, or an optical medium and an access device therefor, and stores various types of data and information used in a position estimating process. For example, the storage device 32 stores a set of parameters for specifying a classifier for detecting a feature from an image, a map to be updated, and identifying information of each vehicle 2. The storage device 32 further stores feature data and travel information received from each vehicle 2 and fixed sensor signals received from each fixed sensor 3. For each fixed sensor 3, the storage device 32 further stores sensing position information indicating the position of a vehicle 2 that can be sensed by the fixed sensor 3. When the fixed sensor 3 is a surveillance camera, the sensing position information includes real-space position coordinates corresponding to respective points in an image generated by the surveillance camera. Alternatively, the sensing position information may include parameters related to the surveillance camera, such as the installed position, the orientation, the focal length, and the angle of view of the surveillance camera. When the fixed sensor 3 is a vehicle sensor, the sensing position information includes real-space position coordinates at which the vehicle sensor can sense a vehicle 2. The sensing position information only has to be transmitted to the server 4 from the fixed sensor 3 when the fixed sensor 3 is installed. Alternatively, the sensing position information may be inputted via a user interface of the server 4. The storage device 32 may further store a computer program executed by the processor 34 for executing the position estimating process.

The memory 33, which is another example of a storage unit, includes, for example, nonvolatile and volatile semiconductor memories. The memory 33 temporarily stores various types of data generated during execution of the position estimating process.

The processor 34, which is an example of a control unit, includes one or more central processing units (CPUs) and a peripheral circuit thereof. The processor 34 may further include another operating circuit, such as a logic-arithmetic unit or an arithmetic unit. The processor 34 generates a collection instruction of feature data indicating a collection target region at predetermined intervals or at timing specified by a user, and transmits the generated collection instruction to each vehicle 2 via the communication network 5 and the wireless base station 6. In addition, the processor 34 executes the position estimating process.

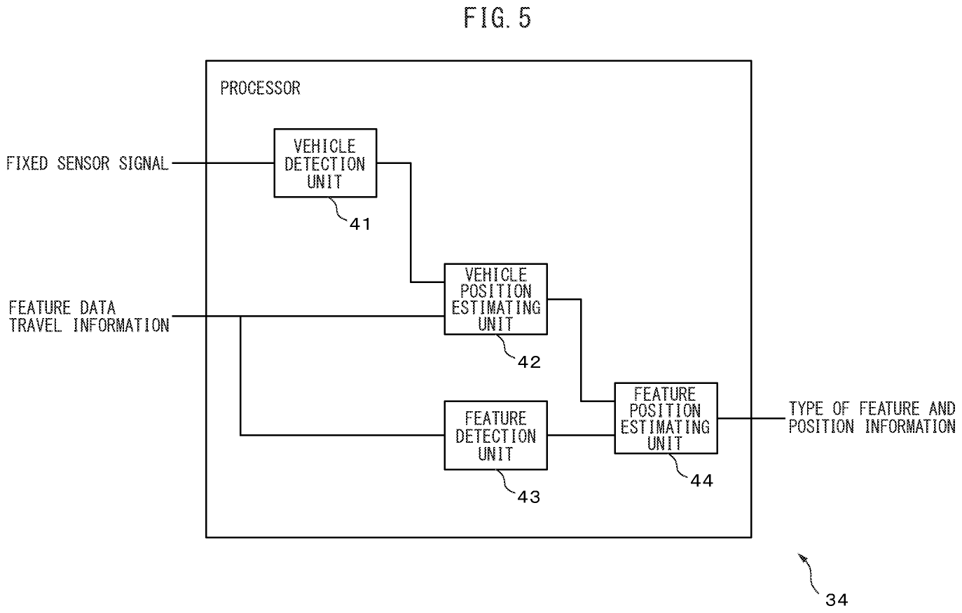

FIG. 5 is a functional block diagram of the processor 34, related to the position estimating process. The processor 34 includes a vehicle detection unit 41, a vehicle position estimating unit 42, a feature detection unit 43, and a feature position estimating unit 44. These units included in the processor 34 are functional modules, for example, implemented by a computer program executed by the processor 34, or may be dedicated operating circuits provided in the processor 34.

The vehicle detection unit 41 detects a first position of a vehicle 2 traveling a predetermined road section at a first time, based on a fixed sensor signal received from a fixed sensor 3.

When the fixed sensor 3 is a surveillance camera, the vehicle detection unit 41 inputs a surveillance image generated by the surveillance camera into a classifier to detect a vehicle 2 traveling a predetermined road section. As such a classifier, the vehicle detection unit 41 can use, for example, a “deep neural network (DNN).” As such a DNN is used, for example, a DNN having architecture of a convolutional neural network (CNN) type, such as Single Shot MultiBox Detector (SSD) or Faster R-CNN, or a DNN having an attention mechanism, such as Vision Transformer. Alternatively, as such a classifier, the vehicle detection unit 41 may use a classifier based on another machine learning technique, such as a support vector machine (SVM) or adaBoost. Such a classifier is trained in advance with a large number of training images representing a vehicle in accordance with a predetermined training technique, such as backpropagation, so as to detect a vehicle from an image.

The classifier may be further trained in advance to detect a license plate. In this case, the vehicle detection unit 41 may identify the registration number of the detected vehicle by inputting a region representing a license plate in a surveillance image into a number-identifying classifier that has been trained to identify a registration number. The vehicle detection unit 41 then identifies an identification number that matches the identified registration number among the identification numbers of the vehicles 2 stored in the storage device 32 or the memory 33. As the number-identifying classifier, the vehicle detection unit 41 can use a DNN of a CNN type or a DNN having an attention mechanism. The vehicle detection unit 41 determines that a vehicle 2 having the identified identification number has been detected. The vehicle detection unit 41 further determines the time of generation of the surveillance image representing the detected vehicle 2 as the first time. Further, the vehicle detection unit 41 identifies a point included in the region representing the detected vehicle 2 in the image or closest to the region among the points associated with real-space position coordinates, and determines the real-space position coordinates corresponding to the identified point as the first position of the detected vehicle 2. The positions of pixels in a surveillance image correspond one-to-one to the directions from the surveillance camera to objects represented in the respective pixels. Thus the vehicle detection unit 41 may determine the first position of the detected vehicle 2, based on the direction from the surveillance camera corresponding to the position of the region representing the vehicle 2 in the surveillance image and parameters of the surveillance camera, such as the installed position and the orientation of the surveillance camera.

Of the vehicles 2, the vehicle detection unit 41 may identify a vehicle traveling through a position closest to the first position at the first time as a vehicle 2 in the first position at the first time by referring to travel information received from the vehicles 2. In this case, the vehicle detection unit 41 may omit to detect a registration number. In addition, the classifier may be trained in advance to further identify the type of the detected vehicle. In this case, of the vehicles 2, the vehicle detection unit 41 may identify a vehicle of the same as the vehicle detected at the first time as a vehicle 2 in the first position at the first time. In this case also, the vehicle detection unit 41 may omit to detect a registration number.

When the fixed sensor 3 is a vehicle sensor or a beacon device, the vehicle detection unit 41 determines a sensing time included in a received vehicle sensing signal as the first time, and a position at which the vehicle sensor can sense a vehicle as the first position. Of the vehicles 2, the vehicle detection unit 41 identifies a vehicle 2 traveling through a position closest to the first position at the first time as a vehicle 2 in the first position at the first time by referring to travel information received from the vehicles 2.

The vehicle detection unit 41 notifies the vehicle position estimating unit 42 of the first time and the first position of the detected vehicle 2.

The vehicle position estimating unit 42 estimates the position of the detected vehicle 2 at the time of generation of an image representing a predetermined feature (second position), based on the first position of the vehicle 2 at the first time; the former time (second time) is included in feature data received from the vehicle 2.

The vehicle position estimating unit 42 calculates a vector extending from the position of the detected vehicle 2 at the first time included in travel information received from the vehicle 2 (hereafter referred to as a “first uncorrected position” for convenience of description) to the first position at the first time detected by the vehicle detection unit 41, i.e., a vector indicating the difference between these positions, as a position correction vector. The vehicle position estimating unit 42 determines a position obtained by correcting the position of the vehicle 2 at the time of generation of the image (second time) included in feature data (hereafter referred to as a “second uncorrected position” for convenience of description) with the position correction vector (i.e., a position obtained by adding the position correction vector to the second uncorrected position) as the second position.

When the travel information does not include a first uncorrected position, the vehicle position estimating unit 42 may determine a first uncorrected position by dividing the segment between the positions of the vehicle 2 at times before and after the first time included in travel information internally in the ratio between the differences between the first time and the times before and after the first time. When the travel information includes odometry information, the vehicle position estimating unit 42 may determine a first uncorrected position by correcting the position of the vehicle 2 at a reference time before or after the first time with the odometry information from the reference time to the first time.

When multiple pieces of feature data are received by the server 4 from the detected vehicle 2, the vehicle position estimating unit 42 estimates, for each piece of feature data, a second position of the vehicle 2 at a second time of generation of an image included in the feature data by executing the above-described processing for each piece of feature data. When multiple images and the times of generation of the images are included in a piece of feature data, the vehicle position estimating unit 42 also estimates, for each image, a second position of the vehicle 2 at a second time of generation of the image by executing the above-described processing for each image.

The vehicle position estimating unit 42 notifies the feature position estimating unit 44 of the estimated second position.

The feature detection unit 43 detects a predetermined feature to be detected, from an image included in feature data received from the detected vehicle 2. To achieve this, the feature detection unit 43 inputs the image into a classifier for feature detection to identify an object region representing a predetermined feature represented in the image and the type of the predetermined feature. As such a classifier, the feature detection unit 43 can use a DNN having architecture of a CNN type or a DNN having an attention mechanism. Alternatively, as such a classifier, the feature detection unit 43 may use a classifier based on another machine learning technique, such as a SVM or adaBoost. Such a classifier is trained in advance with a large number of training images representing a predetermined feature in accordance with a predetermined training technique, such as backpropagation, so as to detect a predetermined feature from an image.

The feature detection unit 43 notifies the feature position estimating unit 44 of the second time of generation of the image from which a predetermined feature is detected, information indicating the position and size of an object region representing the predetermined feature in the image, and the type of the predetermined feature.

The feature position estimating unit 44 estimates the position of the detected feature, based on the second position of the vehicle 2 at the time of generation of the image representing the feature.

As described above in relation to the surveillance camera, the positions of pixels in an image correspond one-to-one to the directions from the camera 11 to objects represented in the respective pixels. Thus, when the detected feature is a feature on the road surface, such as a road marking or a three-dimensional structure placed on the road surface, the feature position estimating unit 44 can estimate the position of the feature in a camera coordinate system where the camera 11 is the origin. Specifically, the feature position estimating unit 44 estimates the position of the feature, based on the direction from the camera 11 corresponding to a reference point in the object region, that travel direction of the vehicle 2 at the second time of generation of the image which is included in feature data, and parameters of the camera 11, such as its orientation and the height at which the camera 11 is mounted on the vehicle 2. The feature position estimating unit 44 can estimate the position of the detected feature, for example, by executing affine transformation of the position of the feature so as to transform the position of the feature in the camera coordinate system into a position in the real-space coordinate system where the position of the camera 11 is the second position. The reference point in the object region may be the centroid of the object region. When the feature is a three-dimensional structure installed on the road surface, the bottom position of the object region is assumed to correspond to the position at which the feature is on the road surface. Thus, in this case, the reference point may be a position on the bottom of the object region.

When the same feature is detected from multiple images generated at different times, the feature position estimating unit 44 may estimate the position of the feature in accordance with the technique of “Structure from Motion.” In this case, the feature position estimating unit 44 estimates the position of the feature by triangulation, based on the second positions and the travel directions of the vehicle 2 at the times of generation of the respective images, the positions of object regions representing the feature in the respective images, and the parameters of the camera 11.

The feature position estimating unit 44 associates the same feature represented in the images generated at different times with each other in accordance with a tracking technique, such as KLT tracking.

The feature position estimating unit 44 stores information indicating the type and the estimated position of the detected predetermined feature in the storage device 32. Alternatively, the feature position estimating unit 44 may output the information indicating the type and the estimated position of the detected feature to another device via the communication interface 31.

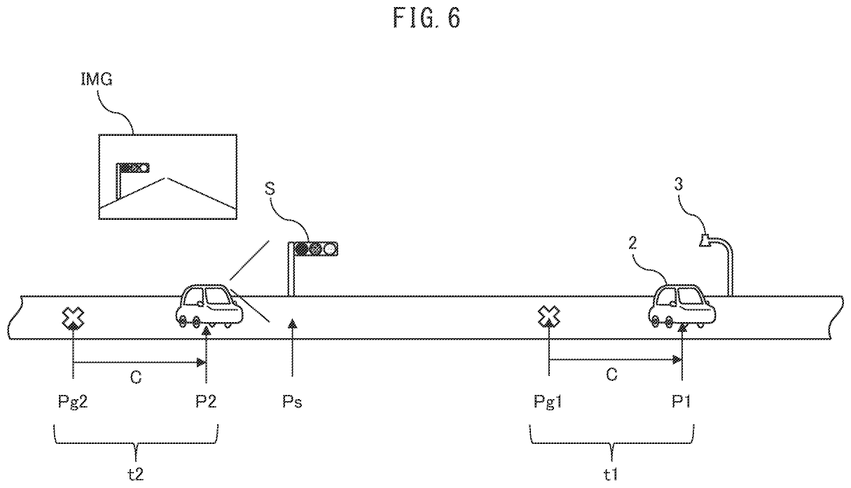

FIG. 6 is a diagram illustrating estimation of the position of a feature according to the present embodiment. As illustrated in FIG. 6, in this example, a first position P1 of a vehicle 2 is detected, based on a fixed sensor signal, at a first time t1 when the vehicle 2 is sensed by a fixed sensor 3. In the vehicle 2, the position Pg1 of the vehicle 2 (first uncorrected position) is detected by the GPS receiver 12 at the first time t1. Thus a position correction vector C=|P1−Pg1| is determined. Using the position correction vector C, the position Pg2 of the vehicle 2 (second uncorrected position) measured by the GPS receiver 12 at a second time t2 when a vehicle-captured image IMG is generated by the camera 11 mounted on the vehicle 2 is corrected to estimate a second position P2 of the vehicle 2 at the time t2. Based on the second position P2, a real-space position Ps of a feature S detected from the vehicle-captured image IMG is estimated.

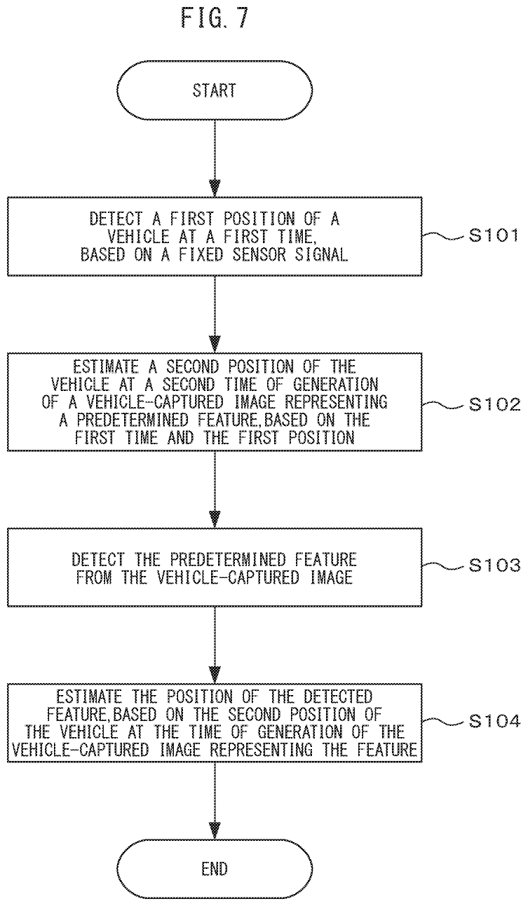

FIG. 7 is an operation flowchart of the position estimating process executed by the server 4. The processor 34 of the server 4 executes the position estimating process in accordance with the operation flowchart described below.

The vehicle detection unit 41 of the processor 34 detects a first position of a vehicle 2 traveling a predetermined road section at a first time, based on a fixed sensor signal received from a fixed sensor 3 (step S101).

Based on the first position of the detected vehicle 2 at the first time, the vehicle position estimating unit 42 of the processor 34 estimates a second position of the vehicle 2 at a second time of generation of a vehicle-captured image representing a predetermined feature to be detected (step S102).

In addition, the feature detection unit 43 of the processor 34 detects the predetermined feature from the vehicle-captured image generated at the second time included in feature data received from the detected vehicle 2 (step S103).

The feature position estimating unit 44 of the processor 34 estimates the position of the detected feature, based on the second position of the vehicle 2 at the time of generation of the vehicle-captured image representing the feature (step S104). The processor 34 then terminates the position estimating process.

The processor 34 may generate or update a map, based on the type and position of the detected feature. For example, the processor 34 adds information indicating the position and type of each detected feature to a map to be generated. When there is not a feature of the same type as the detected feature within a predetermined distance of the position of the detected feature in a map to be updated, the processor 34 adds information indicating the position and type of the detected feature to the map to be updated. When the map to be updated includes information on a feature of a type different from the type of the detected feature at the position of the detected feature, the processor 34 rewrites the type of feature at the position to that of the detected feature. When a feature represented at a predetermined point in the map to be updated is not detected from pieces of feature data collected in a certain period from vehicles 2 passing through the predetermined point, the processor 34 deletes information on the feature at the predetermined point from the map.

The processor 34 may deliver the generated or updated map via the communication network 5 and the wireless base station 6 to a vehicle that uses the map for autonomous driving control or driving assistance.

As has been described above, the position estimating device uses the position of a vehicle detected by a fixed sensor, which can detect the position of a vehicle accurately, for estimating the position of the vehicle at the time of generation of a vehicle-captured image. Thus the position estimating device can estimate the position of the vehicle at the time of generation of a vehicle-captured image accurately. As a result, the position estimating device can accurately estimate the position of a feature detected from the vehicle-captured image.

According to a modified example, only for each of vehicle-captured images from which a predetermined feature is detected by the feature detection unit 43 among a series of vehicle-captured images received from the vehicle 2, the vehicle position estimating unit 42 may estimate the position of the vehicle 2 at the time of generation of the vehicle-captured image. This reduces the amount of computation.

According to another modified example, the vehicle position estimating unit 42 may determine the direction and the amount of movement of the vehicle 2 from the first time of detection of the vehicle 2 by the fixed sensor 3 until the second time of generation of a vehicle-captured image representing a predetermined feature, using odometry information included in travel information. The vehicle position estimating unit 42 may then correct the first position with the direction and the amount of movement to estimate a second position of the vehicle at the second time. This enables the vehicle position estimating unit 42 to estimate a second position of the vehicle 2 even if the GPS receiver 12 mounted on the vehicle 2 fails to determine the position of the vehicle 2 at the second time.

According to another modified example, when the fixed sensor 3 is a surveillance camera, the vehicle detection unit 41 may detect the position of a vehicle 2 from each of surveillance images generated at different times. The vehicle position estimating unit 42 may estimate a second position of the vehicle 2 at the second time, using the position of the vehicle 2 detected from a surveillance image generated at a time closest to the second time of the surveillance images as a first position. In this way, the vehicle position estimating unit 42 uses a surveillance image, which is a fixed sensor signal, generated at a time closest to the time of generation of a vehicle-captured image representing a predetermined feature for estimating the position of the vehicle 2, and thus can further improve the accuracy of estimation of the second position of the vehicle 2.

When multiple fixed sensors 3 are installed, the vehicle detection unit 41 may execute the above-described processing for each fixed sensor 3 to detect a vehicle 2. In this case, when the same vehicle 2 is detected from fixed sensor signals of two or more fixed sensors 3, the vehicle position estimating unit 42 may estimate a second position of the vehicle 2, using the position of the vehicle 2 closer to a second uncorrected position included in travel information among the detected positions of the vehicle 2 as a first position. In this way, the vehicle position estimating unit 42 uses the position of a vehicle 2 detected by a fixed sensor 3 closer to a second uncorrected position of the vehicle 2 at the time of generation of a vehicle-captured image representing a predetermined feature for estimating a second position, and thus can further improve the accuracy of estimation of the second position.

According to still another modified example, the processor 23 of the data acquisition device 14 mounted on the vehicle 2 may execute the processing of the feature detection unit 43 in the above-described embodiment. In this case, the processor 23 includes the time of generation of a vehicle-captured image from which a predetermined feature is detected, the position of the vehicle 2 measured by the GPS receiver 12 and the travel direction of the vehicle 2 at the time of generation, the parameters of the camera 11, and information indicating the position and area of an object region representing the predetermined feature in the vehicle-captured image, in feature data. The feature position estimating unit 44 then estimates the position of the predetermined feature detected from the vehicle-captured image, by referring to these pieces of information included in the feature data.

According to yet another modified example, when the fixed sensor 3 is a surveillance camera, the vehicle detection unit 41 may estimate a blind spot of the vehicle 2, based on a surveillance image. When the estimated position of a feature detected from a vehicle-captured image is within the blind spot, the processor 34 may determine that the feature is erroneously detected, and omit to use information on the feature for generating or updating a map. For example, when not only a vehicle 2 but also another vehicle is detected from a surveillance image, the vehicle detection unit 41 identifies a region covered by the other vehicle as viewed from the vehicle 2 as a blind spot, based on the positional relationship between the vehicle 2 and the other vehicle.

When a beacon device is used as the fixed sensor 3, the data acquisition device 14 of the vehicle 2 may detect the position of the vehicle 2. In this case, a position at which a beacon signal from the beacon device can be received is prestored in the memory 22 of the data acquisition device 14. The processor 23 of the data acquisition device 14 determines the time when a beacon signal emitted from the beacon device is detected by a device mounted on the vehicle 2, as a first time, and detects the position at which a beacon signal can be received as a first position. The processor 23 may include the first time and the first position or a position correction vector in travel information transmitted to the server 4. In this case, the processor 23 of the data acquisition device 14 may further execute the processing of the units of the processor 34 of the server 4 in the above-described embodiment to estimate the position of a detected feature. The processor 23 may then include the estimated position of the feature in feature data. In this case, the data acquisition device 14 is another example of the position estimating device.

The computer program causing a computer to achieve the functions of the units included in the processor of the position estimating device according to the above-described embodiment or modified examples may be provided in a form recorded on a computer-readable storage medium. The computer-readable storage medium may be, for example, a magnetic medium, an optical medium, or a semiconductor memory.

As described above, those skilled in the art may make various modifications according to embodiments within the scope of the present invention.

What is claimed is:

1. A position estimating device comprising:
a processor configured to:
detect a first position of a vehicle traveling a predetermined road section at a first time, based on a fixed sensor installed on or near the predetermined road section,
estimate a second position of the vehicle at a second time, based on the first position of the vehicle at the first time, the second time being a time when a vehicle-captured image representing a predetermined feature is generated by a vehicle-mounted camera mounted on the vehicle, and
estimate a real-space position of the predetermined feature, based on the second position.

2. The position estimating device according to claim 1, wherein the fixed sensor is a surveillance camera that generates surveillance images representing the predetermined road section at predetermined intervals,
the processor detects the position of the vehicle from each of the surveillance images generated at different times, and
the processor estimates the second position, using the position of the vehicle detected from a surveillance image generated at a time closest to the second time of the surveillance images as the first position.

3. The position estimating device according to claim 1, wherein depending on the difference between the first position and a first uncorrected position of the vehicle measured at the first time by a satellite positioning device mounted on the vehicle, the processor corrects a second uncorrected position of the vehicle measured at the second time by the satellite positioning device, thereby estimating the second position.

4. The position estimating device according to claim 1, the processor is further configured to detect the predetermined feature from the vehicle-captured image generated at the second time, wherein
the processor estimates the real-space position of the predetermined feature, based on the position of the predetermined feature in the vehicle-captured image and the second position.

5. A method for estimating a position, comprising:
detecting a first position of a vehicle traveling a predetermined road section at a first time, based on a fixed sensor installed on or near the predetermined road section;
estimating a second position of the vehicle at a second time, based on the first position of the vehicle at the first time, the second time being a time when a vehicle-captured image representing a predetermined feature is generated by a vehicle-mounted camera mounted on the vehicle; and
estimating a real-space position of the predetermined feature, based on the second position.

6. A non-transitory recording medium that stores a computer program for estimating a position, the computer program causing a computer to execute a process comprising:
detecting a first position of a vehicle traveling a predetermined road section at a first time, based on a fixed sensor installed on or near the predetermined road section;
estimating a second position of the vehicle at a second time, based on the first position of the vehicle at the first time, the second time being a time when a vehicle-captured image representing a predetermined feature is generated by a vehicle-mounted camera mounted on the vehicle; and
estimating a real-space position of the predetermined feature, based on the second position.
